(19) United States
(12) Patent Application Publication
(10) Pub. No.: US 2022/0044215 A1
(43) Pub. Date: Feb. 10, 2022

(54) CONSUMER CONTROLLED SHARING OF DETAILS OF RETAIL TRANSACTIONS

(71) Applicant: NIIT TECHNOLOGIES LTD, New Delhi (IN)

(72) Inventor: Shuhab Hajiali Khan YUSUFZAI, Hyderabad (IN)

(21) Appl. No.: 17/250,840

(22) PCT Filed: Sep. 11, 2019
(86) PCT No.: PCT/IN2019/050658

§ 371 Date: Mar. 11, 2021

(30) Foreign Application Priority Data
Sep. 11, 2018 (IN) 201841034103

(51) Int. Cl. G06Q 20/08; G06Q 20/20

(52) U.S. Cl. CPC G06Q 20/0855; G06Q 20/206; G06Q 20/202

(57) ABSTRACT

An aspect of present disclosure facilitates consumer controlled sharing of details of retail transactions. In one embodiment, a server receives a unique code for a retail transaction performed by a user (e.g. consumer), and then retrieves, based on the unique code, details of the retail transaction (including a set of items purchased as part of the retail transaction). The server then stores the details of the retail transaction associated with the user in a non-volatile storage. The server also enables the user to share the details of the transaction (or the information about an item purchased as part of the retail transaction) with third parties such as producers/manufacturers, wholesalers, etc. Accordingly, a user/consumer is provided enhanced control in the sharing of details of their retail transactions.

### PRIORITY CLAIM

The instant patent application is related to and claims priority from co-pending India Provisional Patent Application No. 201841034103, entitled “POT—POINT OF TRANSACTION”, filed 11 Sep. 2018, and naming the same Applicant as in the instant patent application, which is incorporated in its entirety herewith.

### BACKGROUND OF THE DISCLOSURE

### Technical Field

The present disclosure relates to retail systems, and more specifically to consumer controlled sharing of details of retail transactions.

### Related Art

A retail transaction refers to purchase of one or more items by a person (hereafter conveniently assumed to be a consumer) at a retail location. Retail locations may have point-of-sale (POS) devices used for recording the details of the transaction, including the items purchased and the payment information. The consumer is provided a receipt of the details of the retail transaction, for example, on paper and/or by email.

Historically a retailer operating such retail location employs various digital systems (such as backend administrative servers) that collect and process information from multiple POS devices deployed in the location. Accordingly, only the retailer has visibility into the complete set of retail transactions performed at that location.

With a single retailer often operating many retail locations spread across a large geographical area and selling a large number and/or type of items, the single retailer may have exclusive control over the aggregation of the retail information and sharing of the aggregated information (by virtue of the digital systems) with any third parties such as producers/manufacturers, wholesalers, etc.

It may thus be appreciated that the consumer generally has no say in the sharing of the information with third parties. Aspects of the present disclosure are directed to providing enhanced control to consumers in the sharing of details of their retail transactions.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which consumer controlled sharing of details of retail transactions is facilitated according to an aspect of the present disclosure.

FIG. 3 is a block diagram illustrating an example implementation of a server facilitating consumer controlled sharing of details of retail transactions.

FIG. 4A is a block diagram illustrating an example system in which details of retail transactions are stored according to blockchain technology.

FIG. 4B is a block diagram illustrating the manner in which data units are stored in a chain of blocks according to blockchain technology in one embodiment.

FIG. 4C depicts the manner in which transaction data is stored as part of a blockchain in one embodiment.

FIG. 5 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of present disclosure facilitates consumer controlled sharing of details of retail transactions. In one embodiment, a server receives a unique code for a retail transaction performed by a user (e.g. consumer), and then retrieves, based on the unique code, details of the retail transaction. The server stores the details associated with the user in a non-volatile storage and enables the user to share the details with third parties (e.g. producers/manufacturers, wholesalers, etc.).

According to another aspect of the present disclosure, the details of the retail transaction (retrieved by the server, noted above) include information about a set of items purchased as part of the retail transaction. As such, the user (e.g. consumer) is enabled to share the information about an item of the set of items with third parties.

It may be appreciated that the above aspects facilitates a user/consumer to share the details of their retail transactions and/or specific items with third parties directly (instead of relying on a retailer to provide the information to the third parties). Accordingly, a user/consumer is provided enhanced control in the sharing of details of their retail transactions.

According to one more aspect of the present disclosure, the unique code (for the retail transaction) is received (by the server noted above) directly from a personal device of the user. The server also receives a unique identity of the user along with the unique code, and stores the details of the retail transaction along with the unique identity in the non-volatile storage to associate the details with the user.

According to yet another aspect of the present disclosure, the server enables a user (e.g. consumer) to tag the details of a retail transaction (shared with third parties) with the unique identity of the user such that the third parties associate the details with the user.

According to an aspect of the present disclosure, the unique code for a retail transaction is generated by a retail system (containing one or more systems such as Point-Of-Sale (POS) device, retail administration server, etc.), with the user obtaining the unique code from the retail system. As such, when the server (noted above) receives the unique code (for the retail transaction), the server retrieves the details of the retail transaction (including the set of items purchased as part of the retail transaction) from the retail system.

According to another aspect of the present disclosure, the server (noted above) stores the details of a retail transaction in an encoded form in the non-volatile storage, with the encoded form requiring a decode key for decoding. The server shares the details with third parties in the encoded form, with a user (e.g. consumer) providing the decode key to the third parties for the decoding.

According to an aspect of the present disclosure, the non-volatile storage (in which details of retail transactions are stored) is provided as a part of a blockchain. Accordingly, the server stores the details of a retail transaction (along with the unique identity of the user) in a block of the blockchain.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

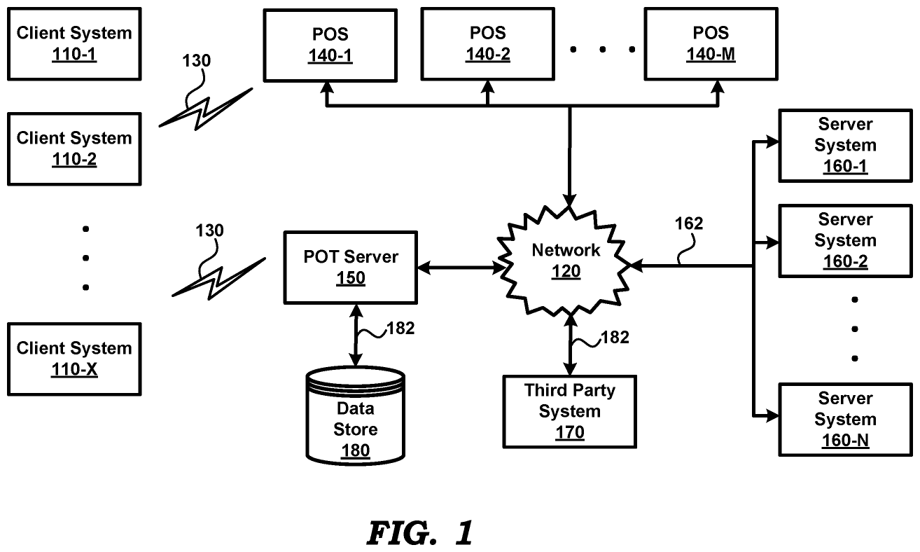

FIG. 1 is a block diagram illustrating an example environment (computing system) in which several aspects of the present disclosure can be implemented. The block diagram is shown containing client systems 110-1 through 110-X, networks 120 and 130, point-of-sale (POS) devices 140-1 through 140-M, point-of-transaction (POT) server 150, server systems 160-1 through 160-N, third party system 170 and data store 180.

Client systems 110-1 to 110-X are collectively or individually referred by referral numeral 110, as will be clear from the context. Similar convention is adapted with respect to POS device 140-1 through 140-M and server systems 160-1 through 160-N also, wherein X, M and N represent any arbitrary positive numbers as suitable in the corresponding environments.

Merely for illustration, only representative number/type of blocks is shown in FIG. 1. Many environments often contain many more blocks, both in number and type, depending on the purpose for which the environment is designed. Each block of FIG. 1 is described below in further detail.

Network 120 represents a data network providing connectivity between POS devices 140, POT server 150, server systems 160, and third party system 170. Network 130 represents a data network providing connectivity between client systems 110, POS devices 140, and POT server 150. Each of networks 120 and 130 may encompass the world-wide connected Internet. Alternatively, each network may be implemented as a local area network (e.g., using wireless and wire-based technologies).

Each of networks 120 and 130 may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is to be directed to a target system when the destination IP address of the packet is set to the IP address of the target system, such that the packet is eventually delivered to the target system by internet 120. When the packet contains content such as port numbers, which specifies a target application, the packet may be directed to such application as well.

Data store 180 represents a non-volatile (persistent) storage and provides for storage and retrieval of data by (applications executing in) POT server 150. Data store 180 may be implemented as a corresponding database server using relational database technologies and accordingly provide storage and retrieval of data using structured queries such as SQL (Structured Query Language). Alternatively (or in addition), data store 180 may be implemented as a corresponding file server providing storage and retrieval of data in the form of files organized as one or more directories, as is well known in the relevant arts.

Each of client systems 110-1 to 110-X represents a system such as a personal computer, workstation, mobile device, computing tablet, etc., used by end users to interact with other systems connected to network 130. In one embodiment, a client system represents a personal device of the end user such as a mobile phone (e.g. iPhone available from Apple Corporation) or a hand held device (also referred to as “smart” device”) that operates with a generic operating system such as Android operating system available from Google Corporation. The client system may include various hardware (and corresponding software) sensors such as camera, microphone, accelerometers, etc. as is well known in the relevant arts.

Each of point-of-sale (POS) devices 140-1 to 140-M represents a system such as a personal computer, workstation, mobile device, computing tablet, etc., used for recording the details of retail transactions, including the items purchased and the payment information, performed at a corresponding retail location. Each POS device 140 is also capable of providing a receipt of the details of the retail transaction, for example, on paper (physical receipt) and/or by email. POS devices 140 may be distributed among multiple retail locations, with one or more of POS devices 140 being located at each retail location.

Each POS device 140 is used by users (e.g. salesmen, retail manager) to generate (retail) requests directed to applications executing in server systems 160A-160N. The retail requests may be generated using appropriate user interfaces (e.g., a web page, a native user interface provided by POS device). In general, a POS device sends a retail request containing one or more commands and may receive the corresponding responses containing the results of execution of the commands.

Each of server systems 160-1 to 160-N represents a server, such as a web/application server, executing one or more software applications capable of processing commands. A server system receives a retail request from a POS device 140 and performs the commands specified (in the request). The server system may use data stored internally (for example, in a non-volatile storage/hard disk within the server), external data (e.g., maintained in a data store) and/or data received from external sources (e.g., received as part of the request) in performing the requested commands. The server system then sends the result of performance of the commands to the requesting POS device (one of 140) as a corresponding response to the retail request. The results may be accompanied by specific user interfaces (e.g., web pages) for displaying the results to the requesting user.

In one embodiment, server systems 160 operate as backend administrative servers that operate to collect and process information from one or more of POS devices 140 (e.g. those belonging to a single retailer). The administrative servers may also perform the aggregation of the collected retail information and facilitate sharing of the aggregated information with any third parties such as producers/manufacturers, wholesalers, etc.

Third party system 170 represents a system such as a personal computer, workstation, mobile device, computing tablet, etc., used by a third party user (such as a producer/manufacturer, wholesaler, etc.) to access the information shared by server systems 160. It may be appreciated that the sharing and access of the information may be performed in a known way. In an alternative embodiment, third party system 170 represents a a server, such as a web/application server, operated by a third party which is used to access the information shared by server systems 160.

It may be appreciated that only retailers have control over the sharing of the information related to retail transactions. However, retail goods or services often have a “supply chain” of Producers/Manufacturers->Wholesalers->Retailers->Consumers, where the producers or manufacturers (e.g. Original Equipment Manufacturers or in short OEMs) create the retail good/services and ship them to one or more wholesalers, who in turn distribute them to one or more retailers, who in turn make them available to consumers.

In such a supply chain, there is often a disconnect between the upstream entities (such as producers/manufactures) and the consumers purchasing the retail goods/services. For example, in gas/petrol stations, neither the producer (Oil Corporation) nor the retailer (Gas Station) has any means to establish a relationship with the consumer at the time of the retail transaction. Cash payments generally go unrecorded i.e., the consumer details are not present for each transaction. Some of the retail locations (such as supermarkets and other retail stores) may not (have the capability to) record the identity of the consumer, and accordingly the retail goods manufacturers may have no means of identifying their loyal consumers.

Even assuming that the identity of the consumer can somehow be recorded at the retail location (for example, using loyalty cards), only the retailers have visibility over the retail transactions performed by consumers. As such, loyalty programs are enabled to be offered only at the level of retailers, with upstream entities unable to offer tailor made consumer specific campaigns.

Furthermore, paper based retail transaction receipts (physical receipts) fail to establish authenticity and legitimacy of the consumer. Often, the bearer of the physical receipt is deemed to be the owner of the retail transaction, even though the retail transaction may have been performed by another person. Warranties offered by the producers/manufacturers (e.g. product warranty) are commonly tied to the physical receipts, with failure to produce the physical receipt for a retail good/service voiding the warranty associated with the retail good/service. Consumers typically need to submit physical receipts for expenses on fuel, medical, travel, etc. to claim tax benefits. Due to the ambiguity around ownership associated with physical receipts, such records are not fool proof.

Point-of-transaction (POT) server 150, provided according to several aspects of the present disclosure, provides enhanced control to users/consumers in the sharing of details of their retail transactions while overcoming some of the drawbacks noted above. The manner in which POT server 150 provides enhanced control to consumers is described below with examples.

### 3. Consumer Controlled Sharing of Details of Retail Transactions

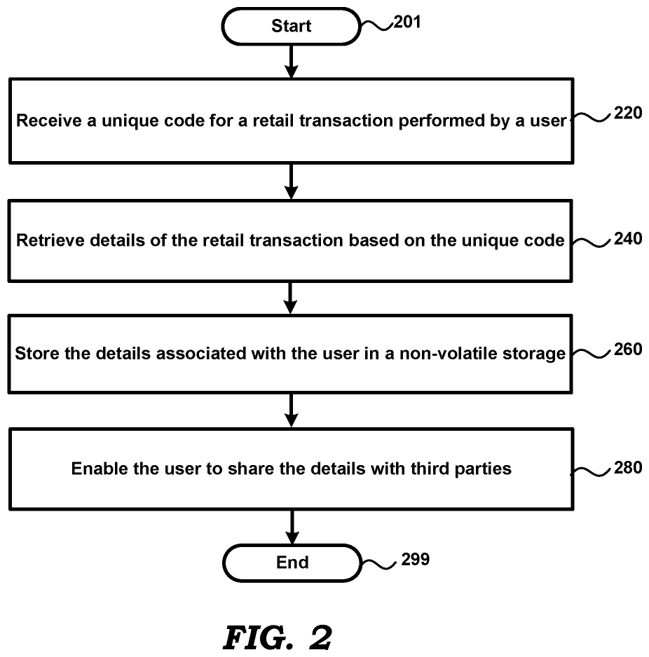

FIG. 2 is a flow chart illustrating the manner in which consumer controlled sharing of details of retail transactions is facilitated according to an aspect of the present disclosure. The flowchart is described with respect to the systems of FIG. 1, in particular POT server 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 220.

In step 220, POT server 150 receives a unique code for a retail transaction performed by a user (e.g. consumer). The unique code may be received from a client system 110 (personal device) of the user. POT server 150 may also receive a unique identity (e.g. phone number, email id) of the user along with the unique code.

In step 240, POT server 150 retrieves details of the retail transaction based on the unique code. The retrieval of the details may entail sending a request containing the unique code to one of server systems 160 and receiving the details of the retail transaction as a response to the request. The details of the retail transaction may include information about a set of items purchased as part of the retail transaction.

In step 260, POT server 150 stores the details associated with the user in a non-volatile storage such as data store 180. In the scenario that a unique identity of the user is received with the unique code, POT server 150 stores the details of the retail transaction along with the unique identity in the non-volatile storage to associate the details with the user.

According to an aspect, the details of the retail transaction is stored in an encoded form in the non-volatile storage, with the encoded form requiring a decode key for decoding. The decode key may be initially available only with the user (from whom the unique code is received in step 220).

In step 280, POT server 150 enable the user to share the details with third parties such as producers/manufacturers, wholesalers, etc. Sharing entails allowing the third parties to access the details of the retail transaction stored in the non-volatile storage. Such sharing of the details may be implemented is any convenient manner.

In the scenario that a unique identity of the user is stored along with the details, POT server 150 also enables the user to tag the details with the unique identity of the user such that the third parties associate the details with the user.

When the details of the retail transaction are stored in an encoded form in the non-volatile storage, POT server 150 may share/allow access to the details in the encoded form with third parties. The user (e.g. consumer) may thereafter provide a decode key to the third parties for decoding the data in encode form (to retrieve the original details). The decode key establishes the ownership of the user over the details of the retail transaction. The flowchart ends in step 299.

It may be appreciated that the tagging is performed only with the consent of the user/consumer. The consumer is accordingly provided complete control as to whether or not they want to reveal their identity to be tagged with each retail transaction and whether they want to share their transaction details with corresponding third parties (e.g. producers/manufacturers, wholesalers, etc.) in order to get tailor made consumer specific offers.

Furthermore, the usage of the decode key enables a user/consumer to claim his/her ownership of a retail transaction without physical receipts. In addition, the user/consumer may submit the details of the retail transaction owned by them for any legal, tax or product warranty purposes. The ownership may also be the basis for the user/consumer's participation in product/brand loyalty programs.

Thus, POT server 150 provides enhanced control to consumers in the sharing of details of their retail transactions with third parties (such as producers and wholesalers). The manner in POT server 150 may be implemented to provide several aspects of the present disclosure according to the steps of FIG. 2 is described below with examples.

### 4. Example Implementation

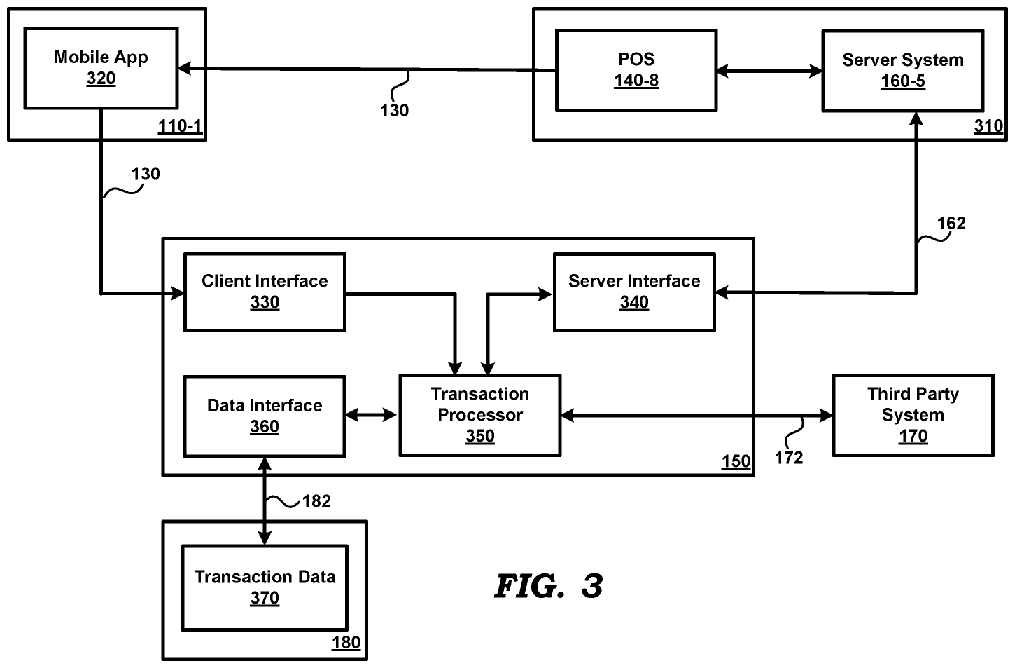

FIG. 3 is a block diagram illustrating an example implementation of a server (POT server 150) facilitating consumer controlled sharing of details of retail transactions. The block diagram is shown containing retail system 310, mobile app (application) 320, client interface 330, server interface 340, transaction processor 350, data interface 360, and transaction data 370. Client interface 330, server interface 340, transaction processor 350 and data interface 360 are shown implemented as part of POT server 150, while transaction data 370 is shown maintained in data store 180. Each of the blocks of FIG. 3 is described in detail below.

Retail system 310 facilitates a retailer to avail services related to retail locations such as inventory management, billing, etc. A retail system commonly contain one or more POS devices 140 provided at retail locations of the retailer and one or more server systems 160 operating as backend administrative servers to the different POS devices belonging to the retailer. For illustration, retail system 310 is shown containing POS device 140-8 provided at a retail location and server system 160-5 operating as a backend administrative/server.

The description is continued assuming a user performs a retail transaction at POS 140-8 located at a retail location of the retailer. In response to the performance of the retail transaction, POS 140-8 sends a request for a unique code for the retail transaction. Server system 160-5, in response to the request, generates a unique Point-of-transaction (POT) code and sends the POT code to POS 140-8 as a response to the request. In one embodiment, the POT code is in the form of a text containing a sequence of characters.

POS 140-8 then provides the POT code to a personal device (here client system 110-1) of the user. For example, POS 140-8 may be send the POT code to client system 110-a using any short range wireless communication protocol such as NFC (Near-Field Communication) or Bluetooth™, well known in the relevant arts. In one embodiment, POS 140-8 prints the POT code as a QR Code (Quick Response Code) on a physical receipt issued to the user for the retail transaction.

Mobile app 320 represents a mobile application executing in a personal device (client system 110-1) of the user. Mobil app 320 facilitates the user to obtain the unique code for a retail transaction from retail system 310. For example, mobile app 320 may use one of the short range protocols noted above to communicate with POS 140-8 and receive the POT code for the retail transaction. In the embodiment that the POT code is provided as a QR code, mobile app 320 facilitates the user to scan (using a camera provided in the personal device) the QR code as an image, and then extracts the POT code from the scanned image. Mobile app 320 then facilitates the user to submit the POT code (along with a unique identity of the user) to POT server 150.

Each of client interface 330, server interface 340 and data interface 360 facilitates POT server 150 to interface with corresponding external systems such as client systems 110, server systems 160 and data store 180. Each of the interfaces may accordingly be implemented consistent with the implementation of the corresponding external system and/or the protocols used for communications with the corresponding external system.

Transaction processor 350 receives (via client interface 330) a unique code (POT code) for a retail transaction performed by a user. The POT code may be received from mobile app 320 executing in a personal device (110-1) of the user. A unique identity (e.g. phone number, email id, IMEI (International Mobile Equipment Identity) number of the personal device) may also be received along with the POT code.

Transaction processor 350 then connects (via server interface 340) with a retail system that generated the POT code to retrieve the details of the retail transaction corresponding to the POT code. The specific retail system (310) to connect with may be determined based on a portion of the POT code (e.g. a specific sequence of characters in the POT code). Alternatively, information about the specific retail system may be received from mobile app 320 along with the POT code. The retrieved details of the retail transaction may include information on the items purchased (by the user) as part of the retail transaction.

After retrieving the details of the retail transaction based on the unique POT code, transaction processor 350 stores (via data interface 360) the retrieved details associated with the user as part of transaction data 370 (in data store 180). In the scenario that a unique identity of the user is received along with the POT code, transaction processor 350 stores the unique identity associated with the details as part of transaction data 370.

Transaction processor 350 also enables the user to share the stored details (in transaction data 370) with third parties such as producers/manufacturers, wholesalers, etc. In one embodiment, the user uses mobile app 320 to send a share request to POT server 150, with the share request indicating (e.g. POT code) the retail transaction to be shared, whether specific or all items of the transaction are to be shared and the specific third party with whom the transaction is to be shared.

In response to the share request, transaction processor 350 may perform the appropriate actions to enable such sharing. For example, when the access to transaction data 370 is controlled using access control lists (ACL), transaction processor 350 includes the specific third party in the ACL for the details (data) and/or specific items associated with the POT code.

Third party users may thereafter use third party system 170 to access details of retail transactions shared by users. Specifically, third party system 170 sends an access request containing the identity of the third party and the POT codes of the retail transactions of interest. Upon receiving the access request, transaction processor 350 determines whether the third party specified in the request is included in the ACL for a retail transaction identified by the POT code. Transaction processor 350 allows access to the details/items of the retail transaction if the third party is included in the ACL for the retail transaction and denies access to the retail transaction otherwise.

Thus, POT server 150 facilitates consumer controlled sharing of details of retail transactions. It may be readily appreciated that the various aspects of the present disclosure operate to ensure the authenticity, legitimacy and ownership of retail transactions performed by a user/consumer. Specifically, the unique code generated by the retail system establishes the authenticity of the retail transaction, the use of the personal device of the user/consumer along with the storing/tagging of the retail transaction with a unique identity of the user establishes the legitimacy of the retail transaction, while the decode key establishes the ownership of the consumer over the retail transaction.

According to an aspect of the present disclosure, the non-volatile storage used to store transaction data (the details of retail transactions associated with the user/consumer) is provided as part of a blockchain. The description is continued with an brief introduction to blockchain technology followed by the manner in which transaction data is stored in a blockchain.

### 5. Blockchain Technology

As is well known, blockchain technology refers to use of a chain of blocks to store data, with each block in the chain storing the signature of a previous block in the chain. Consistency of a signature (in a current block) with the content of the previous block is deemed to be a condition of the existence of the link in the chain between the previous block and the current block. Accordingly, any change in one block of the chain would require alteration of all subsequent blocks in the chain for the validity of the corresponding chain.

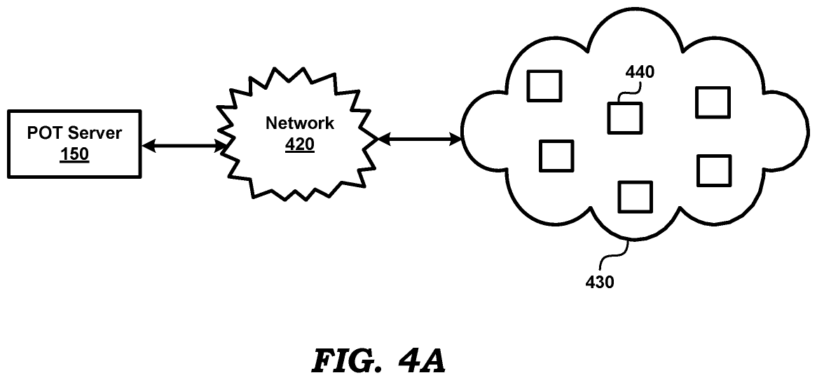

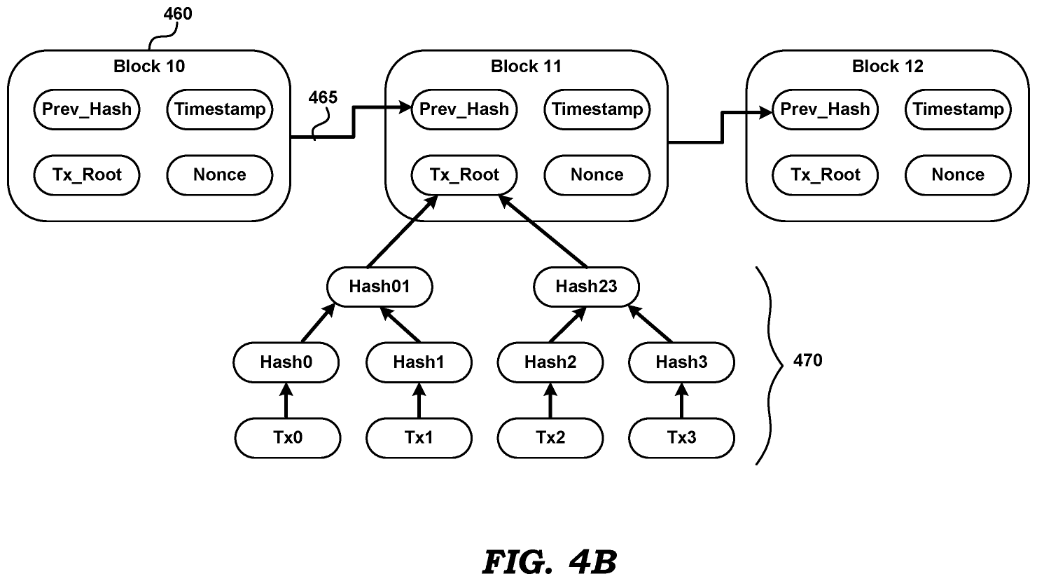

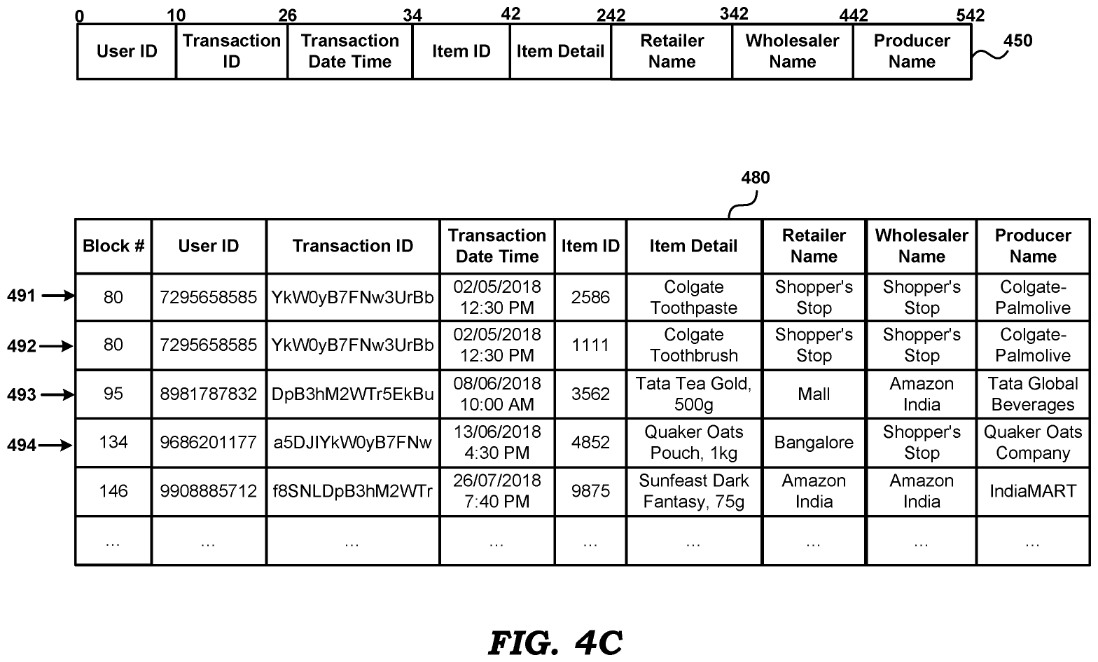

FIG. 4A is a block diagram illustrating an example system in which details of retail transactions are stored according to blockchain technology. The block diagram is shown containing network 420 and blockchain instance 430 (in turn shown containing blockchain node 440). Each of the blocks of FIG. 4A is described in detail below.

Network 420 provides connectivity between (nodes in) blockchain instance 430 and POT server 150. Network 420 may be the same as or be implemented similar to network 120 noted above, and accordingly the description is not repeated here for conciseness.

Blockchain instance 430 represents a chain of blocks storing data according to blockchain technology. Each block is stored in a persistent storage supported by corresponding non-volatile memory of a digital processing system. The blocks may be located across multiple systems/nodes (shown as square boxes within the cloud) such as blockchain node 440. Blockchain instance 430 also supports a set of operations such as reading a blockchain block and writing to a blockchain block, etc. The set of operations may be performed by different nodes in blockchain instance 430 with the nodes coordinating with each other on a user-to-user (or peer-to-peer) basis, thereby providing a decentralized data store.

Blockchain node 440 represents a single node in blockchain instance 430 that may be storing some of the chain of blocks locally (in a non-volatile storage associated with the node). Blockchain node 440 also has the capability to receive requests for specific operations, perform the operations on the blocks maintained locally or on blocks located in other nodes of blockchain instance 430, and to send corresponding responses to the requests.

FIG. 4B is a block diagram illustrating the manner in which data units are stored in a chain of blocks according to blockchain technology in one embodiment. Blockchain 460 represents a chain of blocks storing data according to blockchain technology. For illustration, blockchain 460 is shown containing 3 blocks—block 10, block 11 and block 12. However, a blockchain chain may contain fewer or larger no. of blocks (in the range of 1000+), as will be apparent to one skilled in the relevant arts.

Each block (e.g. 11) is shown containing a “Prev_Hash” field that stores a hash (signature) of previous block 10. As noted above, consistency of the “Prev_Hash” value with a hash generated (using a hash function, as is well known) based the content of previous block 10 is a requisite condition for the existence of link 465 between block 11 and previous block 10. The consistency of other links in the blockchain chain may be similarly determined and validated.

“Timestamp” field stores a unique time value that is associated with the blockchain block at the time of creation of the block. The value for the “Timestamp” field is generated by a unique timestamp server/node present in blockchain 430. “Nonce” field stores an arbitrary random number that is typically used once to provide additional security from decryption attacks.

“Tx_Root” represents a root node of a hash tree (470) using which transactions Tx0, Tx1, Tx2, etc. can be validated. As is well known, a hash tree is a tree data structure in which every leaf node (Hash0, Hash1, etc.) is labelled with the hash of a data block (transaction) and every non-leaf node (Hash01, Hash23, etc.) is labelled with the cryptographic hash of the labels of its child nodes. Such a tree data structure can be used to quickly verify any alteration to the data blocks (transactions). It should be appreciated that nodes of hash tree 470 and also the transactions are typically maintained as part of blockchain block 11.

The manner in which transaction data (370) specifying details of retails transactions may be stored using blockchain technologies is described below with examples.

### 6. Storing Transaction Data Using Blockchain

FIG. 4C depicts the manner in which transaction data is stored as part of a blockchain in one embodiment. Data model 450 represents a format in which details of retail transaction is stored in a block of the blockchain. Data model 450 is shown containing data elements “User ID” indicating a unique identity (mobile number) of the user, “Transaction ID” indicating the unique POT code for the retail transaction, “Transaction Date Time” indicating the date and time of the retail transaction, “Item ID” indicating a unique identifier of an item purchased as part of the retail transaction, “Item Detail” indicating information on the item, “Retailer Name” indicating the name of the retailer with whom the retail transaction took place, “Wholesaler Name” indicating the name of the wholesaler, and “Producer Name” indicating the name of the producer/manufacturer.

It may be observed that a data unit count (assumed to be byte for illustration) is shown on top of the data model to indicate the length of each of the data elements in terms of the number of data units (bytes). For example, the data unit count indicates that data element “UserID” is 10 bytes long (from 0 to 10), data element “TransactionID” is 16 bytes long (from 10 to 26), etc.

Table 480 depicts sample retail transactions that may be stored in blockchain blocks using data model 450. The description is continued assuming that each transaction is stored in a corresponding blockchain block. However, in alternative embodiments, each blockchain block may store a different number and/or type of transactions, as will be apparent to one skilled in the relevant arts by reading the disclosure herein.

Column “Block #” specifies the block identifier that uniquely identifies the blockchain block in which the corresponding retail transaction is maintained. It may be observed that rows 491 and 492 specify the information of the various items purchased as part of a single transaction (with ID “YkW0yB7FNw3UrBb”), and accordingly both the rows are indicated as being maintained in the same blockchain block 80. Rows 493 and 494 specify the details of other retail transactions and are shown to be maintained in corresponding other blocks of the blockchain.

Thus, each retail transaction is facilitated to be recorded by a consumer using mobile app 310 which in turn causes an itemized list of transaction details to be stored in a secured blockchain instance 430. It may be appreciated that once the details of a retail transaction is stored in the blockchain, the transaction becomes “immutable” due to the operation of blockchain technology. As the consumer is deemed as the owner of each block of transaction in his/her blockchain instance, consumer will have complete control over privacy of their retail transactions. A softcopy of transaction receipt (POT Receipt) may be sent to the email of the consumer and also made available on mobile app 310. The POT receipt may used for any warranty claims or reimbursements or for tax filing purposes.

In addition, as each retail transaction (itemized list) in blockchain instance 430 is tagged with corresponding consumer's identity with the consent of consumer, the data in blockchain instance 4430 provides visibility to upstream entities (manufactures, wholesalers, etc.) of their consumer base. As such, the upstream entities may reach out to their end consumers with more relevant promotional campaigns.

It should be further appreciated that the features described above can be implemented in various embodiments as a desired combination of one or more of hardware, software, and firmware. The description is continued with respect to an embodiment in which various features are operative when the software instructions described above are executed.

### 7. Digital Processing System

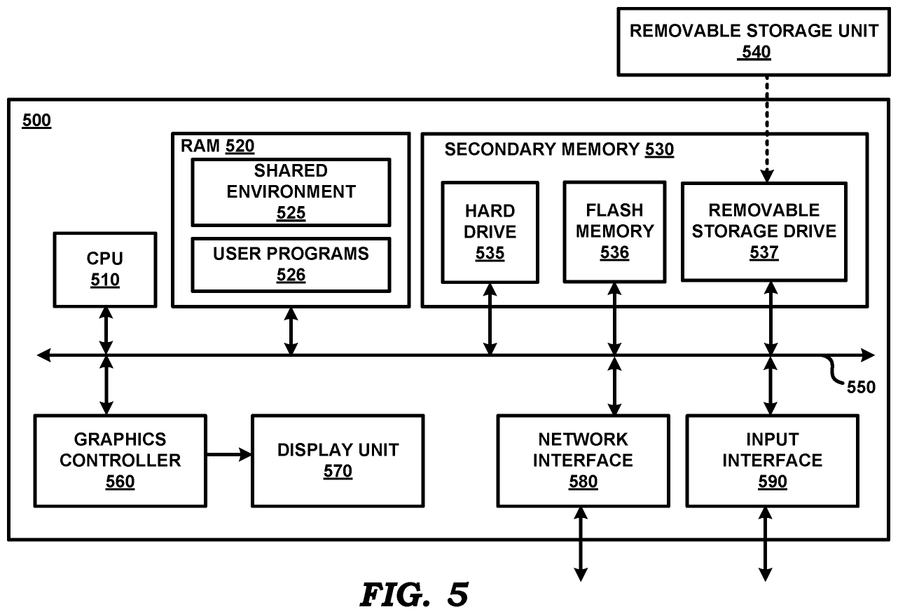

FIG. 5 is a block diagram illustrating the details of digital processing system 500 in which various aspects of the present disclosure are operative by execution of appropriate executable modules. Digital processing system 500 may correspond to POT server 150.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting shared environment 525 and/or other user programs 526 (such as other applications, DBMS, etc.). In addition to shared environment 525, RAM 520 may contain other software programs such as device drivers, virtual machines, etc., which provide a (common) run time environment for execution of other/user programs.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 580 provides connectivity to a network (e.g., using Internet Protocol), and may be used to communicate with other systems (of FIG. 1) connected to the networks (120 and 130).

Secondary memory 530 may contain hard drive 535, flash memory 536, and removable storage drive 537. Secondary memory 530 may store the data (for example, data portions shown in FIG. 4C) and software instructions (for example, for implementing the various features of the present disclosure as shown in FIG. 2, etc.), which enable digital processing system 500 to provide several features in accordance with the present disclosure. The code/instructions stored in secondary memory 530 may either be copied to RAM 520 prior to execution by CPU 510 for higher execution speeds, or may be directly executed by CPU 510.

Some or all of the data and instructions may be provided on removable storage unit 540, and the data and instructions may be read and provided by removable storage drive 537 to CPU 510. Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 8. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A method performed in a server, said method comprising:
receiving a unique code for a retail transaction performed by a user;
retrieving, based on said unique code, details of said retail transaction;
storing said details associated with said user in a non-volatile storage; and
enabling said user to share said details with third parties.

2. The method of claim 1, wherein said details includes information about a set of items purchased as part of said retail transaction,
wherein said enabling enables said user to share the information about an item of said set of items with third parties.

3. The method of claim 1, wherein said unique code is received directly from a personal device of said user, wherein a unique identity of said user is received along with said unique code, wherein said details are stored along with said unique identity in said non-volatile storage to associate said details with said user.

4. The method of claim 3, wherein said enabling enables said user to tag said details with said unique identity such that said third parties associate said details with said user.

5. The method of claim 4, wherein said unique code is generated by a retail system, wherein said user obtains said unique code from said retail system, wherein said retrieving retrieves said details from said retail system.

6. The method of claim 5, wherein said details are stored in an encoded form in said non-volatile storage, said encoded form requiring a decode key for decoding,
wherein said details are shared with said third parties in said encoded form, wherein said user provides said decode key to said third parties for said decoding, wherein said decode key establishes the ownership of said user over said details.

7. The method of claim 1, wherein said non-volatile storage is provided as a part of a blockchain, wherein said storing stores the details of said retail transaction in a block of said blockchain.

8. A non-transitory machine readable medium storing one or more sequences of instructions, wherein execution of said one or more instructions by one or more processors contained in a server causes said server to perform the actions of:
receiving a unique code for a retail transaction performed by a user;
retrieving, based on said unique code, details of said retail transaction;
storing said details associated with said user in a non-volatile storage; and
enabling said user to share said details with third parties.

9. The non-transitory machine readable medium of claim 8, wherein said details includes information about a set of items purchased as part of said retail transaction,
wherein said enabling enables said user to share the information about an item of said set of items with third parties.

10. The non-transitory machine readable medium of claim 8, wherein said unique code is received directly from a personal device of said user, wherein a unique identity of said user is received along with said unique code, wherein said details are stored along with said unique identity in said non-volatile storage to associate said details with said user.

11. The non-transitory machine readable medium of claim 10, wherein said enabling enables said user to tag said details with said unique identity such that said third parties associate said details with said user.

12. The non-transitory machine readable medium of claim 11, wherein said unique code is generated by a retail system, wherein said user obtains said unique code from said retail system, wherein said retrieving retrieves said details from said retail system.

13. The non-transitory machine readable medium of claim 12, wherein said details are stored in an encoded form in said non-volatile storage, said encoded form requiring a decode key for decoding,
wherein said details are shared with said third parties in said encoded form, wherein said user provides said decode key to said third parties for said decoding, wherein said decode key establishes the ownership of said user over said details.

14. The non-transitory machine readable medium of claim 8, wherein said non-volatile storage is provided as a part of a blockchain, wherein said storing stores the details of said retail transaction in a block of said blockchain.

15. A computing system comprising:
a retail system to generate a unique code for a retail transaction performed by a user;
a personal device of said user to obtain the unique code from the retail system; and
a server operable to:
receive from said personal device, said unique code for said retail transaction;
retrieve from said retail system, based on said unique code, details of said retail transaction;
store said details associated with said user in a non-volatile storage; and
enable said user to share said details with third parties.

16. The computing system of claim 15, wherein said details includes information about a set of items purchased as part of said retail transaction,
wherein said server enables said user to share the information about an item of said set of items with third parties.

17. The computing system of claim 15, wherein said server receives a unique identity of said user along with said unique code, wherein said details are stored along with said unique identity in said non-volatile storage to associate said details with said user.

18. The computing system of claim 17, wherein said server enables said user to tag said details with said unique identity such that said third parties associate said details with said user.

19. The computing system of claim 18, wherein said details are stored in an encoded form in said non-volatile storage, said encoded form requiring a decode key for decoding,
wherein said details are shared with said third parties in said encoded form, wherein said user provides said decode key to said third parties for said decoding, wherein said decode key establishes the ownership of said user over said details.

20. The computing system of claim 15, wherein said non-volatile storage is provided as a part of a blockchain, wherein said server stores the details of said retail transaction in a block of said blockchain.
